(19) United States
(12) Patent Application Publication
(10) Pub. No.: US 2025/0387761 A1
(43) Pub. Date: Dec. 25, 2025

(54) THERMALLY-INTENSIFIED INTERFACIAL POLYMERIZATION FOR ULTRA-SELECTIVE REVERSE OSMOSIS MEMBRANES

(71) Applicant: The University of Hong Kong, Hong Kong (HK)

(72) Inventors: Shenghua ZHOU, Hong Kong (HK); Hao GUO, Hong Kong (HK); Chuyang TANG, Hong Kong (HK)

(21) Appl. No.: 19/243,658

(22) Filed: Jun. 19, 2025

Related U.S. Application Data
(60) Provisional application No. 63/662,429, filed on Jun. 21, 2024.

(51) Int. Cl. B01D 69/12; B01D 61/02; B01D 67/00; B01D 69/02; B01D 69/10; B01D 71/56

(52) U.S. Cl. CPC B01D 69/1251; B01D 67/0006; B01D 69/02; B01D 69/107; B01D 71/56; B01D 61/025; B01D 2323/081; B01D 2323/219; B01D 2323/40; B01D 2323/42; B01D 2325/20

(57) ABSTRACT

This invention provides a device to enable thermally intensified interfacial polymerization for facile fabrication of ultra-selective reverse osmosis (RO) membranes for various water treatment scenarios including seawater desalination and water reuse. The device pre-heated the organic solvent and then performed interfacial polymerization between the room-temperature aqueous phase and the heated organic phase. The fabricated RO membranes demonstrated excellent selectivity towards toxic micropollutants (i.e., boron in seawater, arsenite in groundwater, and organic micropollutants in wastewater) and high water-permeability. This invention offers a facile, cost-efficient and highly effective alternative for water treatment.

### CROSS-REFERENCE TO RELEVANT APPLICATIONS

The present application claims priority from U.S. Provisional Utility Patent application No. 63/662,429 filed Jun. 21, 2024; the disclosure of which is incorporated by reference herein in its entirety.

### FIELD OF THE INVENTION

The present invention relates to water treatment. More specifically, a device for fabricating ultra-selective reverse osmosis membranes is provided herewith for removal of toxic micropollutants.

### BACKGROUND

Sustainable clean water supply is vital for public health and socioeconomic development, yet nearly one third of the global population lacks reliable access to safe drinking water.

Reverse osmosis (RO) has been widely used to recover clean water from unconventional water sources (i.e., seawater, brackish groundwater, and wastewater) through desalination and water reuse. Fundamentally, clean water recovery using RO membranes is a pressure-driven method by separating dissolved solutes, including salts, organic contaminants, and micropollutants, from water.

RO technology is widely adopted in municipal, industrial, and household applications due to its high efficiency, scalability, and ability to produce potable water from saline or contaminated sources. Today, RO produces over 88 million cubic meters of desalted water per day, showing its immense potential to augment clean water supply.

Among various types of RO membranes, thin-film composite (TFC) polyamide membranes are highly favorable due to their high water permeance without compromising solute rejection.

Despite widespread usage, current RO membranes face persistent challenges. One major issue is the trade-off between water permeance and solute rejection. Membranes with high permeance typically suffer from reduced selectivity, while those with superior selectivity often exhibit low water flux. This compromise limits the operational efficiency and cost-effectiveness of RO systems. Furthermore, existing membranes often exhibit limited rejection of organic micropollutants with low molecular weights such as pharmaceutical residues and endocrine-disrupting compounds (EDCs), raising significant public health and environmental concerns.

Existing thin film composite (TFC) polyamide RO membranes can achieve reasonable water permeance and >99% NaCl rejection. Nevertheless, they often showed poor rejection of some toxic and harmful micropollutants with severe environmental and health concerns. For example, boron, a small neutral compound (molecular weight=68.1 g mol⁻¹ and pKa=9.2), is ubiquitously found in seawater. Current commercial RO membranes often show insufficient boron rejection of <80% at circumneutral pH, which needs a second-pass RO polishing step to meet the boron concentration requirement for drinking and agricultural uses.

Another example of toxic micropollutant is arsenite (As (III)), which is classified as a Group 1 human carcinogen by the International Agency for Research on Cancer, and is highly bio-accumulative and toxic due to its high bioavailability and ease of cellular uptake. Therefore, unsatisfactory rejection of arsenite is highly problematic in groundwater treatment.

EDCs, typically synthetic preservatives like parabens (i.e., methylparaben, ethylparaben, propylparaben and butylparaben) and phthalates (i.e., di(2-ethylhexyl) phthalate (DEHP) and dibutyl phthalate (DBP)) are widely used in personal care products, pharmaceuticals and food packaging, and are frequently detected in municipal and industrial wastewater. There is an imminent need for the rejection of these parabens as they may interfere with human hormonal systems at even trace concentrations (ng/L to μg/L).

Likewise, inadequate rejection of antibiotics (e.g., sulfamethoxazole, sulfadiazine, norfloxacin and ofloxacin), especially from agricultural and medical effluent, may pose significant healthcare risk as residual antibiotics may promote the proliferation of antibiotic-resistant bacteria.

To address these challenges, new generations of RO membranes with high selectivity against micropollutants are urgently needed.

The selectivity of a TFC RO membrane strongly depends on the crosslinking degree (and thus the effective pore size) of its polyamide rejection layer, which is fabricated by interfacial polymerization (IP) between m-phenylenediamine (MPD) and trimesoyl chloride (TMC).

Numerous efforts have been made to narrow the effective pore size of the polyamide layer to improve membrane selectivity, such as incorporating additives into monomer solutions and post-treating the fabricated membranes. However, selectivity enhancement is often at the expense of sacrificed water permeance, commonly known as the trade-off effect between permeance and selectivity.

A criterion to overcome this effect is to tailor the chemistry and nanostructure of polyamide during its formation through IP reaction. Raising the reaction temperature can significantly accelerate the diffusion of amine monomers from the aqueous phase to the organic phase, thus promoting the IP process.

Attempts to optimize both water permeance and selectivity have been made but inevitably involve post-heat treatment and other additional processes, which in turn increases the production cost and rendering these fabrication methods less optimal for batch fabrication.

Therefore, there is a need in the art for an improved fabrication process of RO membranes with both high water permeance and selectivity, without post-treatment or additional processes. The present invention addresses this need.

### SUMMARY OF THE INVENTION

The first aspect of the present invention provides a method of fabricating a reverse osmosis (RO) membrane through thermally intensified interfacial polymerization (TIP). The method comprises providing a porous substrate layer, providing a first aqueous solution comprising a diamine monomer at room temperature, providing a second solution comprising acyl chloride monomers dissolved in an organic solvent and pre-heating the second solution to a temperature in a range of 25° C. to 100° C., immersing the porous substrate layer to the first solution for 1-3 minutes and removing excess first solution from the porous substrate layer to obtain a diamine-impregnated substrate, and applying the second solution to the diamine-impregnated substrate to form a polyamide rejection layer on the diamine-treated substrate and obtain the reverse osmosis membrane.

Specifically, the RO membrane fabricated by the method described above exhibits a rejection of at least 90% against solutes with molecular weights of 100 g mol⁻¹ or higher; and a pure water permeance of at least 1 L m⁻² h⁻¹ bar⁻¹.

In an embodiment of the first aspect of the present invention, the diamine monomer is m-phenylenediamine.

In another embodiment, the acyl chloride monomers are trimesoyl chloride monomers.

In another embodiment, the porous substrate layer is polysulfone.

In yet another embodiment, the organic solvent is Isopar G.

In various embodiments, the RO membrane exhibits a boron rejection of at least 70%, a NaCl rejection of at least 95% and an As (III) rejection of at least 97%. The RO membrane also exhibits a rejection of at least 90% against parabens and a rejection of at least 95% against sulfadiazine, sulfamethoxazole, sulfamethazine, norfloxacin and ofloxacin.

In a second aspect of the present invention, a polyamide rejection layer fabrication apparatus for thermally intensified interfacial polymerization is also provided. The apparatus comprises an organic solution container configured to hold an organic solvent containing an acyl chloride monomer, a heater configured to heat the organic solution in the organic solution container to a temperature of no higher than 166° C., a temperature sensor configured to measure the temperature of the organic solution, a temperature controller connected to an external processor, configured to receive the data received from the temperature sensor, and to regulate the operation of the heater to achieve a target temperature, and a solution outflow gap configured to controllably dispense the organic solution heated to the target temperature onto a porous substrate layer through the control of a valve.

In an embodiment of the second aspect of the present invention, the organic solution container comprises stainless steel or corrosion-resistant metals.

In another embodiment, the valve is manually or electromechanically actuated.

In yet another embodiment, the organic solvent is Isopar G, and the porous substrate layer is a polysulfone membrane pre-impregnated with m-phenylenediamine.

### BRIEF DESCRIPTION OF THE DRAWINGS

FIG. 1 shows a line drawing of the device for pre-heating organic phase with indication of its structural components.

FIGS. 2A to 2D depict the separation performances of various TIP RO membranes. FIG. 2A compares the pure water permeances of the TIP RO membranes. FIG. 2B depicts the rejection of NaCl, boron, and As (III) by the TIP RO membranes. FIG. 2C depicts the rejection of EDCs and antibiotics by the TIP RO membranes. FIG. 2D compares the NaCl, boron, As (III), EDC, and antibiotic rejection by TIP100 to literature data in the current state of the art. All the rejection data is acquired from the filtration tests at a neutral pH of 6-8. The TIP25, TIP50, and TIP100 correspond to the membranes fabricated using Isopar G as organic solvent at temperature of 25° C., 50° C., and 100° C., respectively.

FIGS. 3A to 3F depict the thermal effects on MPD diffusion and membrane properties. FIG. 3A shows the ultraviolet-visible (UV) absorbance of MPD diffused in the Isopar G at different temperature (i.e., 25° C., 50° C., and 100° C.). FIG. 3B depicts the crosslinking degrees of the formed polyamide TIP membranes (i.e., TIP25, TIP50, and TIP100, respectively). FIG. 3C depicts the ionized carboxyl group densities of TIP membranes (i.e., TIP25, TIP50, and TIP100, respectively). This result is obtained following a reported silver binding method. FIG. 3D depicts the Zeta potentials of TIP membranes (i.e., TIP25, TIP50, and TIP100, respectively).

FIG. 3E depicts the S parameter of TIP25 and TIP100 characterized by Doppler broadening energy spectroscopy (DBES). FIG. 3F depicts the rejection of four neutral molecules (i.e., ethanol, ethylene glycol, glycerol, and glucose) with different molecular weights by TIP25 and TIP100 membranes. The error bars represent the standard deviation obtained from at least three independent measurements of different membranes.

FIGS. 4A to 4D depict the microscopic characterizations of various TIP RO membranes. FIG. 4A demonstrates surface morphology of the membranes characterized by the scanning electron microscope (SEM). FIG. 4B shows the surface structure and roughness of the membranes characterized by the atomic force microscope (AFM), with Rq being the root mean square roughness. FIG. 4C shows cross-sectional structure of the membranes characterized by transmission electron microscopy (TEM). FIG. 4D presents SEM images of back-side openings for polyamide layers. FIG. 4E demonstrates the back opening diameters measured from back-side SEM images. FIG. 4F demonstrates the nanovoid fraction of the polyamide layers. This value is calculated by the area of nanovoids over the entire area of the polyamide layer based on the TEM cross-sectional images. FIG. 4G demonstrates the surface area ratio of the membranes, which is calculated by dividing the true surface area of a membrane sample by its projected area. The error bars represent the standard deviation obtained from at least three independent measurements of different membranes.

FIGS. 5A to 5D illustrates membrane selectivity and fouling behavior. FIG. 5A demonstrates water permeance and water-NaCl selectivity for TIP100 compared with literature data. FIG. 5B demonstrates water permeance and water-boron selectivity for TIP100 as compared to literature data in the current state of the art. All data is obtained from the filtration tests conducted at a neutral pH of 6-8. FIG. 5C demonstrates the normalized flux of TIP25 and TIP100 during the fouling-cleaning test over 50 h, while normalized flux is the ratio of the water flux at time t (Jₜ) to the initial water flux (J₀, 15 L m⁻² h⁻¹ in this study). The fouling test is performed using a feed solution of 0.1 g L⁻¹ humic acid (HA) and 2 g L⁻¹ NaCl at pH7 for 48 h. The fouled membrane is subsequently cleaned with DI water, followed by the filtration of 2 g L⁻¹ NaCl for 2 h. FIG. 5D illustrates reversible and irreversible flux reduction, and HA accumulation for TIP25 and TIP100 after the 48-h fouling tests. The error bars represent the standard deviation obtained from at least three independent measurements of different membranes.

FIGS. 6A and 6B demonstrates selected properties of the TIP membranes. FIG. 6A shows the Fourier-transform infrared spectroscopy (FTIR) of TIP RO membranes. FIG. 6B shows the average roughness (Ra) of TIP RO membranes. The characteristic peak of FTIR spectra at 1663 cm⁻¹ and 1541 cm⁻¹ (as shown FIG. 6A), belonging to amine I and amine II band, confirmed the successful synthesis of fully aromatic polyamide layers. Specifically, when organic phase temperature raised from 25° C. to 100° C., Ra increased from 47.1 nm to 71.3 nm, which could be attributed to the enlarged void structures.

FIG. 7 shows the XPS spectra of TIP RO membranes.

FIG. 8 demonstrates the water contact angle (WCA) of TIP RO membranes. The effects of Isopar G temperature on the wetting properties of TIP RO membranes are further investigated. As shown in FIG. 8, the WCA increased from 59.9° for TIP25 to 72.4° for TIP100. This change can be attributed to a reduced number of ionized carboxyl groups due to a higher crosslinking degree (as shown in FIG. 3).

### DETAILED DESCRIPTION

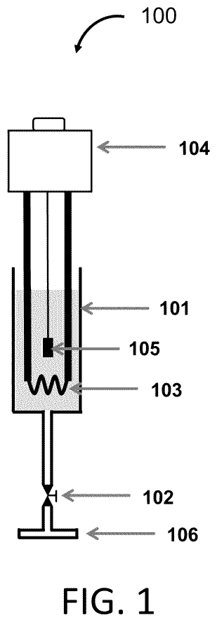

In accordance with the various embodiments of the present invention, an ultra-selective polyamide RO membrane using a custom-designed thermal-intensified IP (TIP) device is provided. As shown in FIG. 1, the custom-designed TIP device 100 comprises a stainless-steel container 101 equipped with a valve 102, a heater 103, temperature controller 104 with a temperature sensor 105, and a solution outflow gap 106.

The device 100 enables thermally intensified interfacial polymerization to fabricate ultra-selective RO membranes for various water treatment scenarios including seawater desalination and water reuse. The device 100 pre-heats the organic solvent of Isopar G (boiling point=166° C.) to 100° C. and then performs an IP reaction to prepare the membrane through interfacial polymerization between the room-temperature aqueous phase and the heated organic phase.

Consequently, the TIP membrane exhibits superior rejection of various toxic micropollutants (i.e., >85% for boron, and ≥98.9% for EDCs and antibiotics). At the same time, the membrane shows enhanced water permeance due to the increased nanovoid content and larger surface area.

These features enable the membrane to achieve ultra-selective removal of micropollutants and thus overcoming the permeance-selectivity trade-off. Experimental results indicate that the TIP is a facile strategy to fabricate ultra-selective RO membranes toward effective membrane-based desalination, groundwater treatment, and water reuse.

The device 100 is capable of pre-heating an organic solvent to a specific temperature in a facile manner, as regulated by a temperature controller. It is worth noting that raising the reaction temperature can significantly accelerate the diffusion of amine monomers from the aqueous phase to the organic phase, thus promoting the interfacial polyamide (IP) process. Meanwhile, molecular motion would become more rapid at higher temperature due to the increased kinetic energy, which leads to more frequent collisions between the reactant molecules. Moreover, higher temperature would enable more molecules with sufficient energy to overcome the energy barrier required for the IP reaction. These effects could significantly promote the IP reaction to form a more crosslinked polyamide thereby potentially improving membrane selectivity.

### ILLUSTRATION OF THE EMBODIMENTS OF THE INVENTION BY EXAMPLES

### Example 1: Method and Apparatus

### 1.1 Preparing TMC Solution at Different Temperature

First, the TMC monomers are dissolved in a Isopar G solution at room temperature (i.e., 25° C.) in the device 100. The heater 103 of the device 100 raised the temperature of the solution, while the temperature controller 104 ensured that heating ceased once the designated temperature is attained.

### 1.2 Fabricating Polyamide RO Membranes

Polyamide RO membranes are synthesized through a thermal-intensified interfacial polymerization (TIP) between the MPD solution (dissolved in DI water at room temperature (i.e., 25° C.), 2 wt. %) and TMC solutions (dissolved in Isopar G, 0.1 wt. %) at different temperature (i.e., 25° C., 50° C., and 100° C.). To initiate the TIP reaction, a polysulfone (PSf) substrate is firstly immersed in MPD solution for 2 min, after which the excess MPD solution is removed using a rubber roller. Next, the TMC solution at various temperature is poured from the container onto the substrate for 1 min, forming the polyamide rejection layer.

### Example 2: Experimental Results

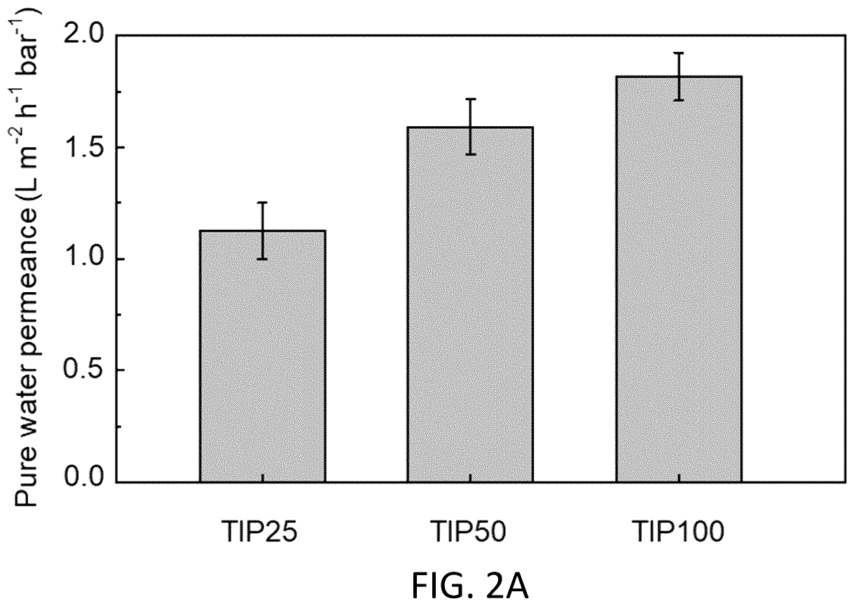

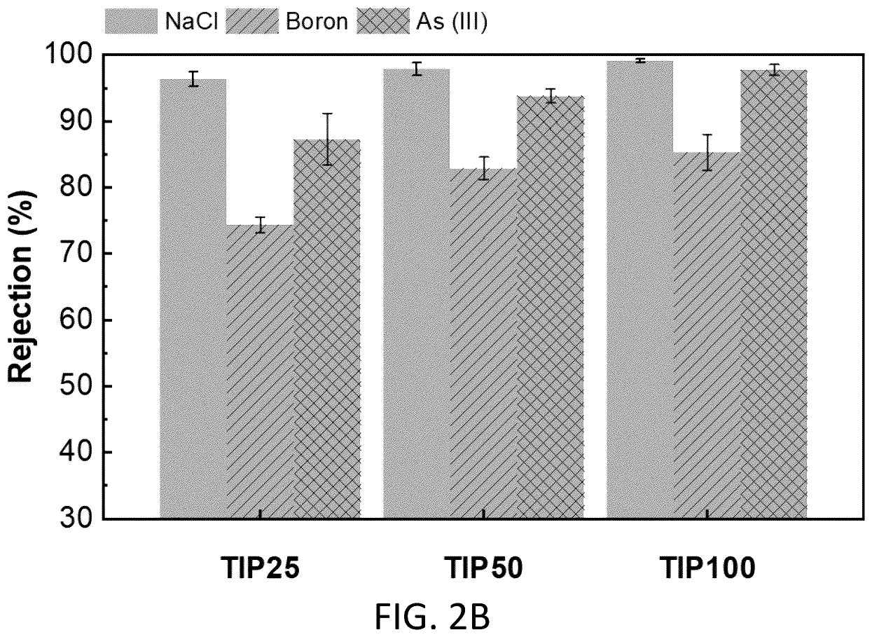

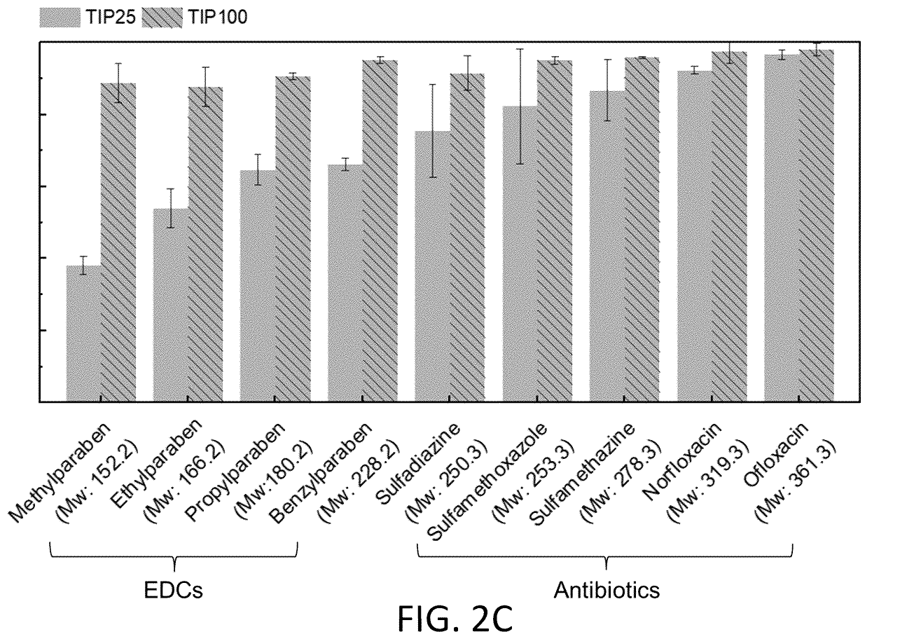

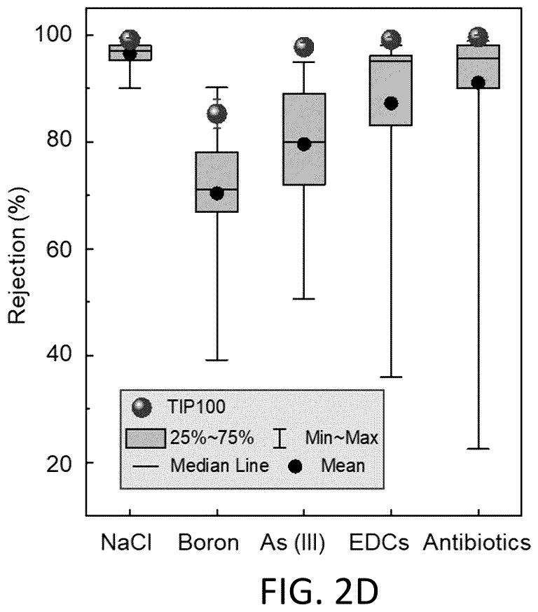

The TIP RO membranes are fabricated by performing the IP reaction between MPD (dissolved in water at room temperature (i.e., 25° C.)) and TMC (dissolved in Isopar G at different temperature). The formed membranes are named as TIP25, TIP50, and TIP100 corresponding to the temperature of Isopar G (i.e., 25° C., 50° C., and 100° C., respectively). As shown in FIGS. 2A-2D, the separation performance improved significantly for the polyamide membranes fabricated at higher organic solvent temperature. With an increase in temperature from 25° C. to 100° C. (referring to FIG. 2A), water permeance is enhanced. Simultaneously, a significant enhancement in NaCl rejection is also observed (referring to FIG. 2B). Specifically, TIP100 exhibited an attractive combination of water permeance (1.8 L m⁻² h⁻¹ bar⁻¹) and NaCl rejection (99.1%). In addition, increasing organic solvent temperature and additional heat treatment also improved the rejection of As (III) and boron, respectively. The membrane rejection to a variety of organic micropollutants is further evaluated, such as EDCs and antibiotics (referring to FIG. 2C), due to their critical concerns for public health. TIP100 achieved very high rejection of these compounds. Even for methylparaben, a neutral compound with molecular weight as small as 152.2 g mol⁻¹, the rejection by TIP100 reached 98.9%, confirming the beneficial effect of using high organic phase temperature on improving membrane rejection. Notably, TIP100 achieved superior rejection for the broad spectrum of contaminants (99.1% for NaCl, 85.2% for boron (at pH7), 97.6% for As (III) (at pH7), and ≥98.9% for all the nine organic micropollutants (at pH7)), consistently overperforming against other membranes reported in the literature on the current state of the art (referring to FIG. 2D).

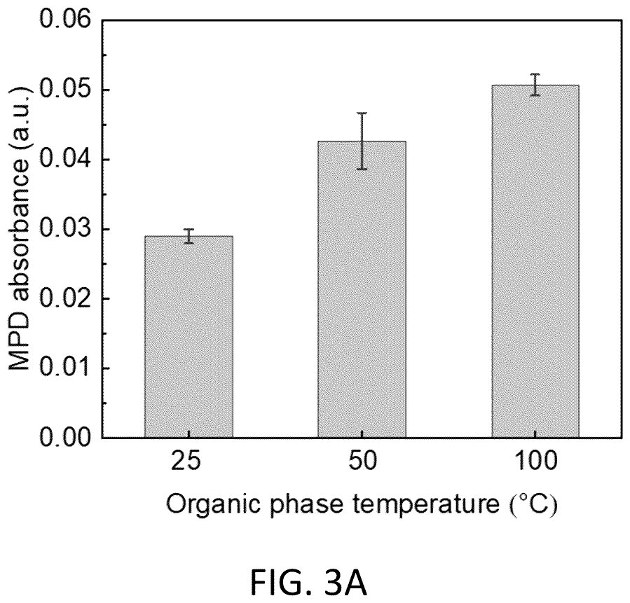

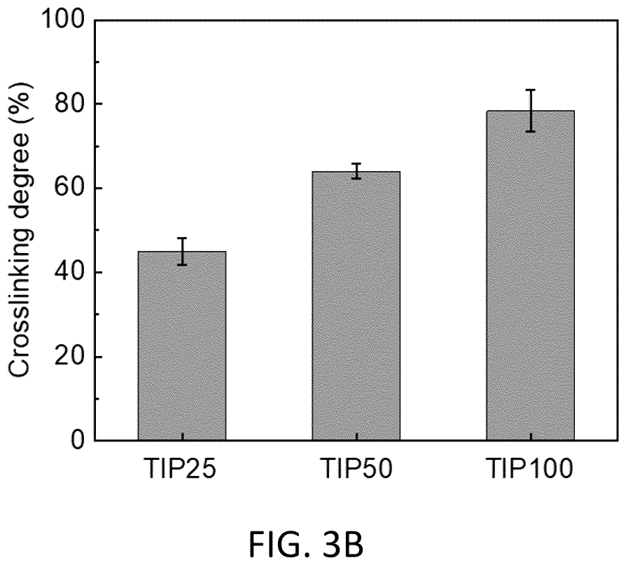

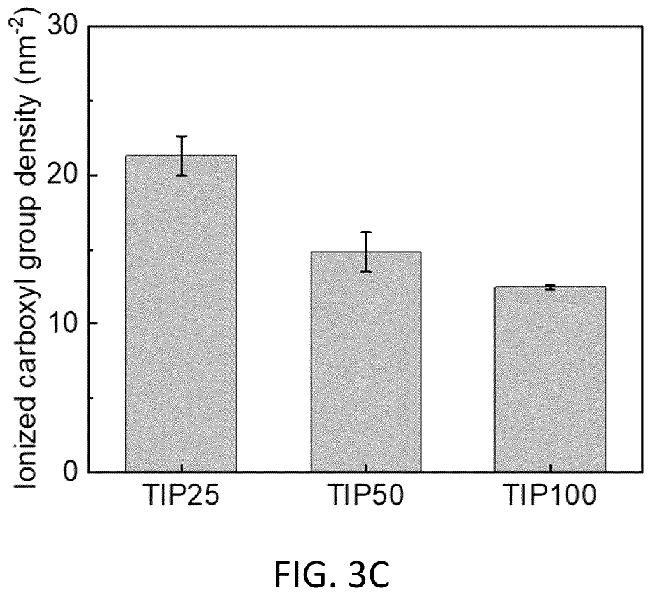

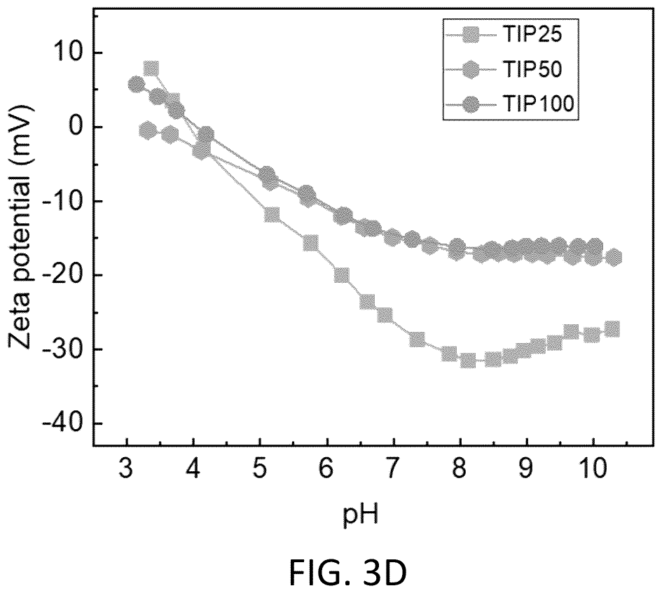

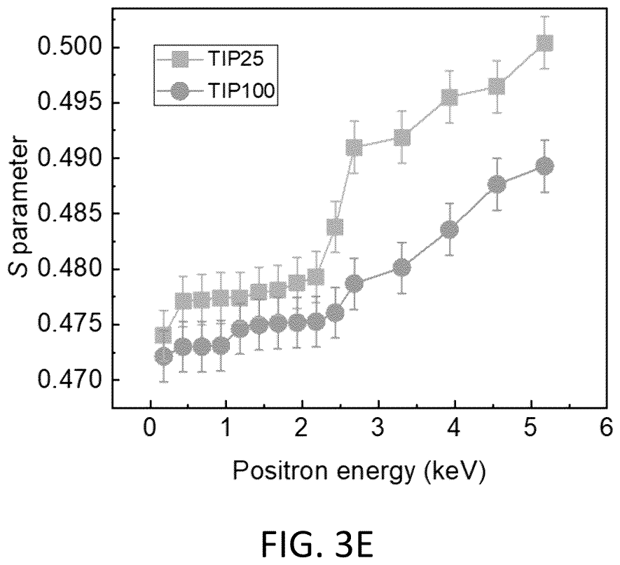

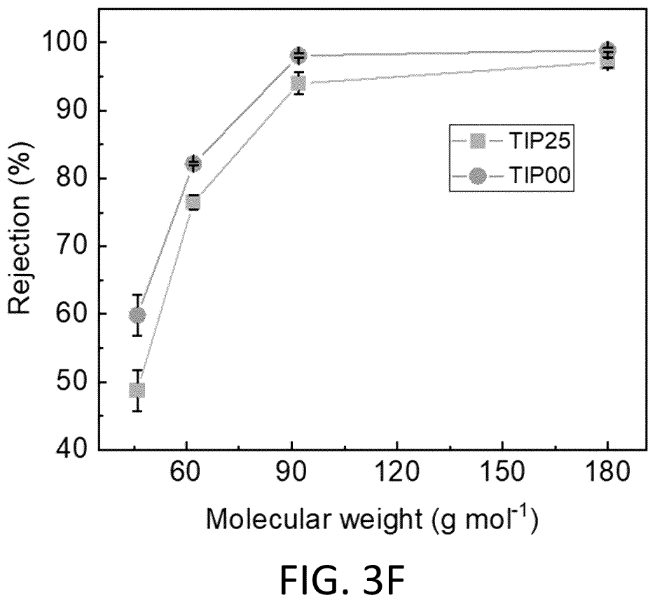

As shown in FIG. 3A, the diffusion of MPD monomers accelerated at higher organic phase temperature. Specifically, the ultraviolet-visible (UV) absorbance of MPD monomers in 100° C. Isopar G is higher than that in the 25° C. identical solution. This result indicated an increased amine monomer supply for the IP reaction as the organic phase temperature raised. A larger MPD supply can benefit the IP reaction, forming a better-crosslinked polyamide layer, which is well consistent with the increased crosslinking degree from 44.9% at 25° C. to 78.4% at 100° C. (referring to FIG. 3B). Consistently, the density of ionized carboxyl groups (formed by hydrolysis of unreacted acyl chloride groups) decreased from 21.3 nm⁻² for TIP25 to 12.5 nm⁻² for TIP100 (referring to FIG. 3C). Fewer ionized carboxyl groups further resulted in less negatively charged membrane surfaces (referring to FIG. 3D).

To further investigate the effects of organic phase temperature on the pore size of the polyamide membranes, DBES characterizations have been performed in this study. Since a lower S parameter value corresponds to the smaller pore size, the lower S parameter value of TIP100 (referring to FIG. 3E) verified the smaller pore size of this membrane compared to TIP25. In addition, rejection tests using TIP25 and TIP100 membranes were conducted for four neutral solutes (referring to FIG. 3F), as their rejection behaviors are mainly governed by the size exclusion effect. Notably, TIP100, fabricated at higher temperature, achieved better rejection for these molecules compared with TIP25, indicating a smaller pore size. These results demonstrated that improving IP temperature can promote the crosslinking of polyamide chains and narrow the pore size of polyamide membranes.

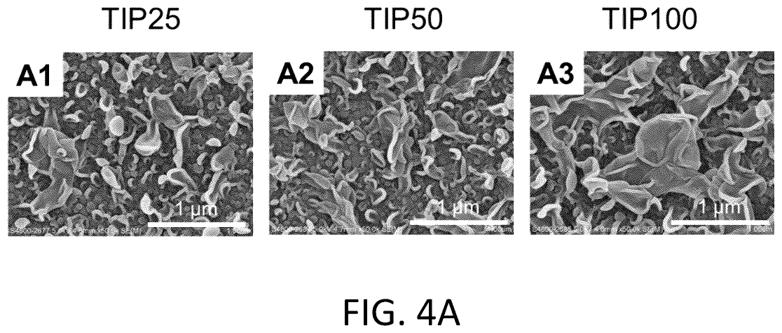

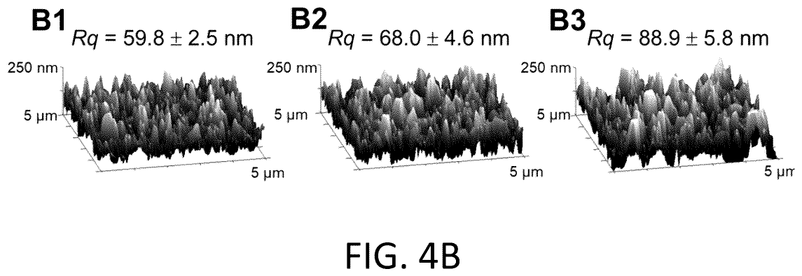

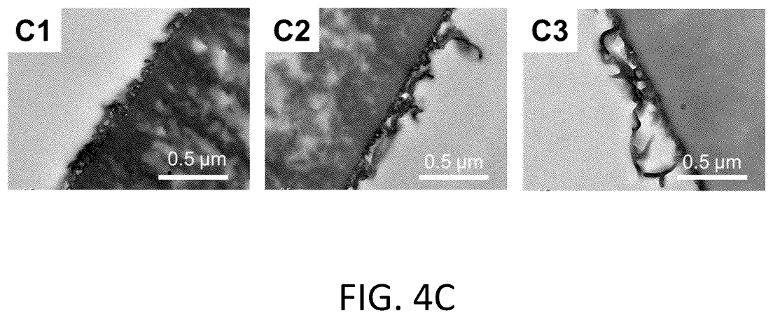

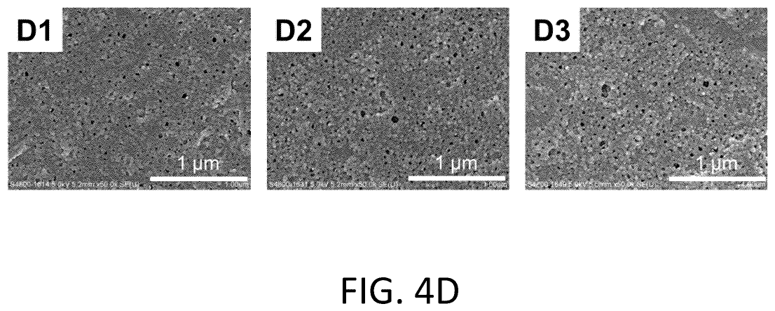

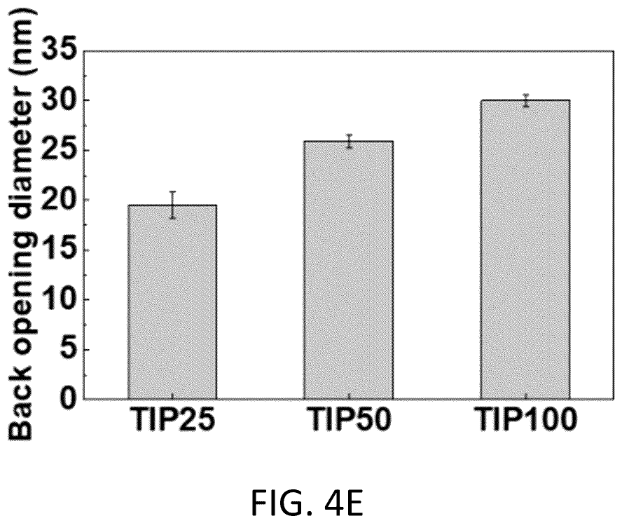

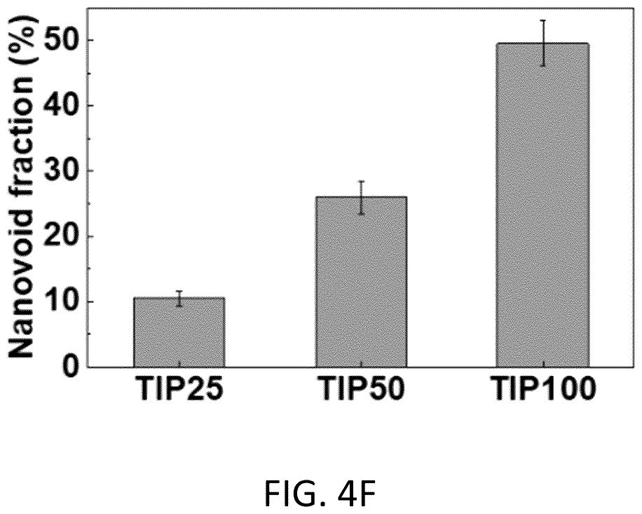

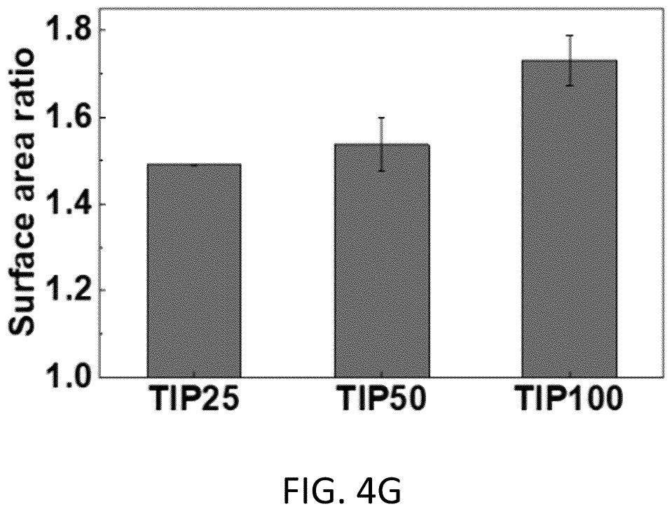

As shown in FIG. 4A, the temperature of organic phase significantly influenced the surface morphology of the resulting polyamide RO membranes. Increasing the temperature from 25° C. to 100° C. led to the enlargement of “leaf-like” features on the membranes. Consistently, membrane surface roughness substantially increased from 59.8 nm for TIP25 to 88.9 nm for TIP100 as determined by AFM measurements (referring to FIG. 4B). Additionally, TEM characterizations revealed the presence of more prominent nanovoids within the polyamide rejection layers formed at higher temperature (referring to FIG. 4C). For example, TIP100 had the largest nanovoid with a size up to ˜0.5 μm, corresponding to the most extensive “leaf-like” features among the four polyamide layers (referring to FIG. 4A). The enlargement of nanovoid structures can be attributed to the stronger interfacial degassing of nanobubbles, resulting from the intensified IP reaction at higher temperature. At the same time, the more intense release of nanobubbles also led to larger back opening (referring to FIGS. 4D and 4E). Consequently, the membranes fabricated at higher temperature displayed a greatly increased nanovoid fraction (i.e., 50.0% for TIP100), which is much higher than that of 10.5% for TIP25 (referring to FIG. 4F). Meanwhile, membrane surface area ratio is also significantly increased (referring to FIG. 4G), indicating a more effective filtration area. Such increased nanovoid fraction and surface area optimizes the water transport pathway with reduced resistance, leading to enhanced membrane water permeance (referring to FIG. 2A).

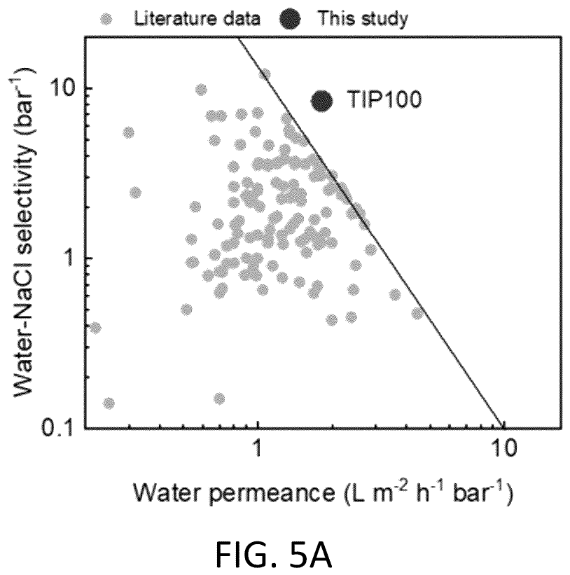

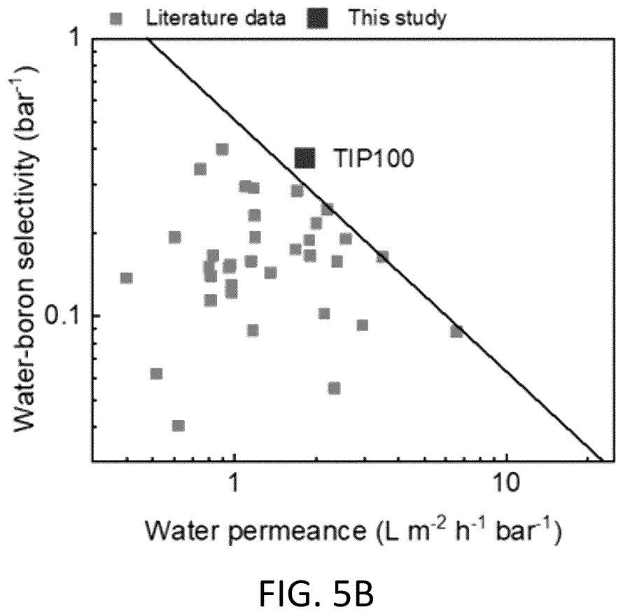

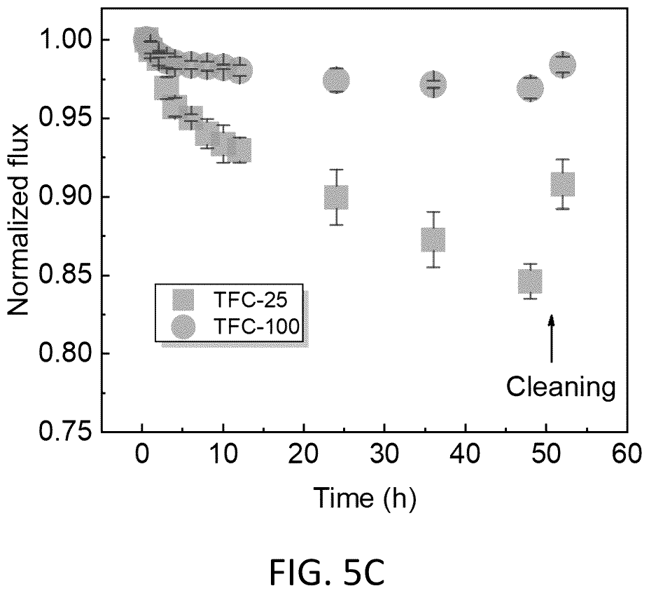

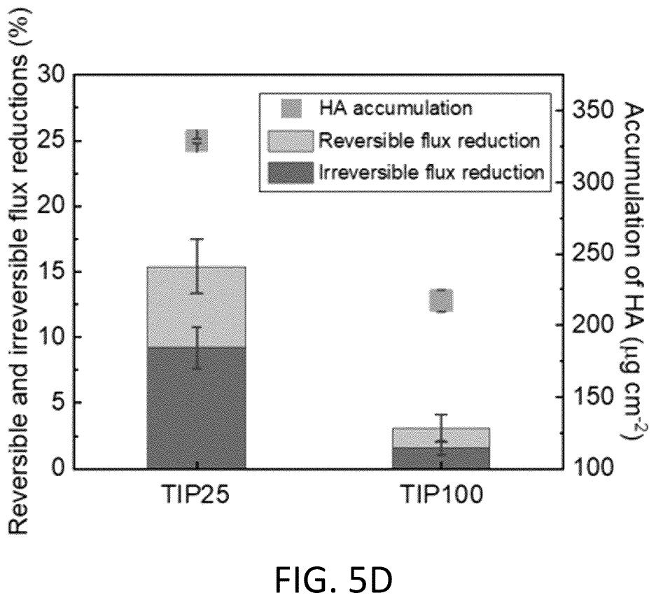

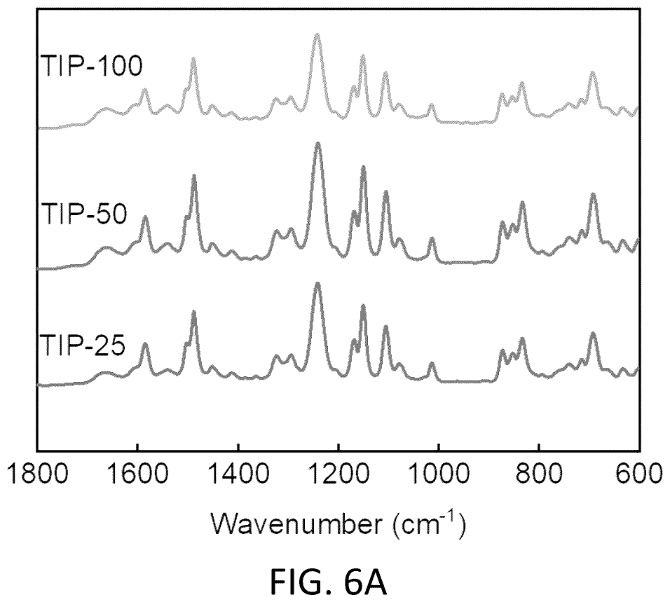

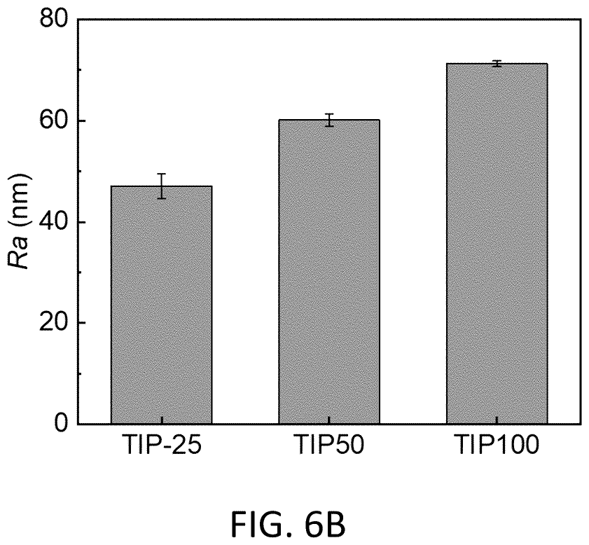

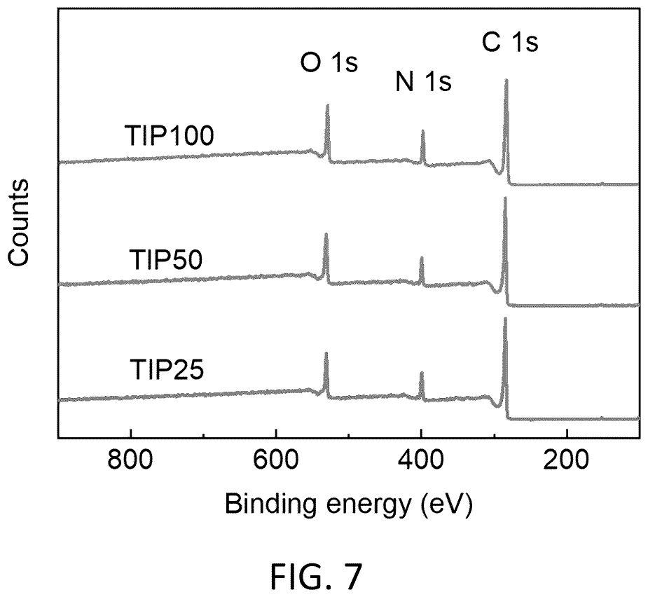

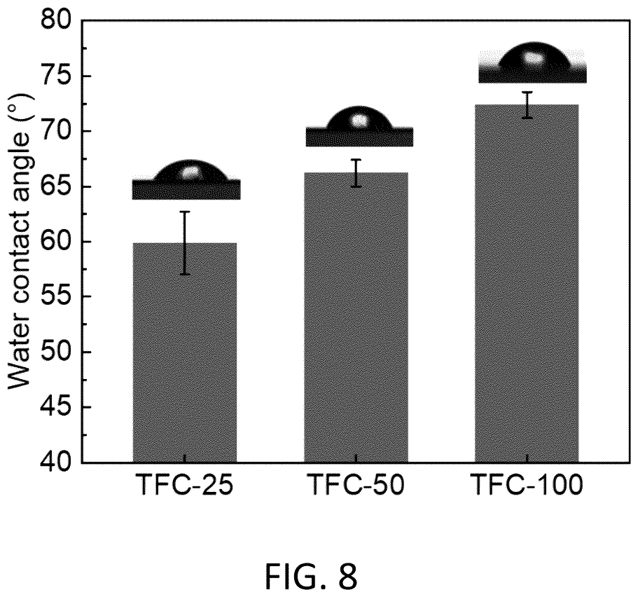

The TIP100 membrane showed a higher water-NaCl selectivity than most of the RO membranes (referring to FIG. 5A). Such outstanding water-NaCl selectivity would contribute to more efficient desalination processes. Moreover, TIP100 membrane demonstrated superior boron selectivity, overcoming the trade-off between water permeance and water-boron selectivity (referring to FIG. 5B). Excellent boron selectivity could ensure that the quality of product water meets boron concentration standards for drinking and irrigation without requiring a secondary RO step.

The fouling behavior of TIP25 and TIP100 membranes are further evaluated using HA as the foulant. TIP100 membrane displayed superior antifouling performance, as evidenced by its significantly higher normalized flux (i.e., lower flux reduction) compared to the TIP25 membrane (referring to FIG. 5C). This outcome can be attributed to less HA accumulation on the surface of TIP100 membrane (referring to FIG. 5D) due to more uniform water transport and flux distribution near the extensive nanovoid regions. On the other hand, TIP100 exhibited superior fouling reversibility with a lower irreversible flux reduction (Rᵢᵣ) of 1.6% compared to 9.2% for TIP25. This result could be ascribed to the reduced compaction of the foulant layer for TIP100 membrane, which stems from lower average localized flux and more uniform flux distribution.

Several embodiments of the present disclosure and features of details are briefly described above. The embodiments described in the present disclosure may be easily used as a basis for designing or modifying other processes and structures for realizing the same or similar objectives and/or obtaining the same or similar advantages introduced in the embodiments of the present disclosure. Such equivalent construction does not depart from the spirit and scope of the present disclosure, and various variations, replacements, and modifications can be made without departing from the spirit and scope of the present disclosure.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of +10%, +5%, +1%, or +0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within +10%, +5%, +1%, or +0.5% of the average of the values.

1. A method of fabricating a reverse osmosis membrane through thermally intensified interfacial polymerization, comprising:
providing a porous substrate layer;
providing a first aqueous solution comprising a diamine monomer at room temperature;
providing a second solution comprising acyl chloride monomers dissolved in an organic solvent and pre-heating the second aqueous solution to a temperature in a range of 25° C. to 100° C.;
immersing the porous substrate layer to the first aqueous solution for 1 to 3 minutes and removing excess of the first aqueous solution from the porous substrate layer to obtain a diamine-impregnated substrate;
applying the second aqueous solution to the diamine-impregnated substrate to form a polyamide rejection layer on the diamine-impregnated substrate to obtain the reverse osmosis membrane.

2. The method of claim 1, wherein the reverse osmosis membrane has a pure water permeance of at least 1 L m⁻² h⁻¹ bar⁻¹.

3. The method of claim 1, wherein the reverse osmosis membrane rejects at least 90% of solutes with molecular weights of 100 g mol⁻¹ or higher.

4. The method of claim 1, wherein the diamine monomer is m-phenylenediamine.

5. The method of claim 1, wherein the acyl chloride monomers is trimesoyl chloride monomers.

6. The method of claim 1, wherein the porous substrate layer is polysulfone.

7. The method of claim 1, wherein the organic solvent is Isopar G.

8. The method of claim 1, wherein the reverse osmosis membrane has a boron rejection of at least 70%, a NaCl rejection of at least 95% and an As (III) rejection of at least 97%.

9. The method of claim 1, wherein the reverse osmosis membrane has a rejection of at least 90% against parabens.

10. The method of claim 1, wherein the reverse osmosis membrane has a rejection of at least 95% against sulfadiazine, sulfamethoxazole, sulfamethazine, norfloxacin and ofloxacin.

11. A polyamide rejection layer fabrication apparatus for fabricating a reverse osmosis membrane according to the method of claim 1, comprising:
an organic solution container configured to hold an organic solution containing an acyl chloride monomer;
a heater configured to heat the organic solution in the organic solution container to a temperature of no higher than 166° C.;
a temperature sensor configured to measure a temperature of the organic solution;
a temperature controller configured to receive and process the measured temperature data from the temperature sensor, and to regulate the heater to achieve and maintain a target temperature; and
a solution outflow gap and a value configured to controllably dispense the organic solution heated to the target temperature onto a porous substrate layer.

12. The apparatus of claim 11, wherein the organic solution container is made of stainless steel or corrosion-resistant metals.

13. The apparatus of claim 11, wherein the valve is manually or electromechanically actuated.

14. The apparatus of claim 11, wherein the organic solvent is Isopar G.

15. The apparatus of claim 11, wherein the porous substrate layer is a polysulfone membrane pre-impregnated with m-phenylenediamine.
